(19) United States
(12) Patent Application Publication
(10) Pub. No.: US 2002/0194089 A1
(43) Pub. Date: Dec. 19, 2002

(54) Quote-to-order on-line tool

(75) Inventors: David Clifton, Austin, TX (US); Laurie Dolan, Austin, TX (US); Adam Moore, Austin, TX (US); Dan Isaacs, Cedar Park, TX (US)

Correspondence Address: HAYNES AND BOONE, LLP, 901 MAIN STREET, SUITE 3100, DALLAS, TX, 75202, US

(73) Assignee: Dell USA, L.P., Round Rock, TX (US)

(21) Appl. No.: 10/224,803

(22) Filed: Aug. 21, 2002

Related U.S. Application Data
(63) Continuation of application No. 09/344,391, filed on Jun. 25, 1999.

(51) Int. Cl. G06F 17/60

(52) U.S. Cl. 705/26

(57) ABSTRACT

Method and apparatus for providing a customer with a quote number identifying a selected PC configuration, which quote number can be later provided by the customer either via telephone or web site to facilitate the process of ordering the selected configuration. When a customer completes the configuration of a PC with a sales representative over the telephone, the sales representative provides the customer with a unique quote number identifying the selected configuration, information about the customer, and any other information the possession of which is necessary or useful in subsequently ordering the selected configuration. Later, when the customer has decided to order the PC, he or she simply accesses the web site of the vendor, enters the quote number in the appropriate field, and clicks on a “place order” button or menu selection, thereby ordering the PC on-line. Alternatively, the customer may contact the vendor via telephone and provide the quote number to any available sales representative, whether or not that sales representative originally assisted the customer in configuring the PC, to enable that sales representative to place the order for the customer.

### BACKGROUND

The disclosures herein relate generally to systems for ordering build-to-order personal computers (“PCS”) and, more particularly, to a tool for enabling a telephone quote to be used to facilitate the on-line ordering of a build-to-order PC.

This application relates to co-pending U.S. patent application Ser. No. 09/009,401, filed on Jan. 20, 1998, entitled Method and Apparatus For Providing and Accessing Data at an Internet Site, naming Amy Van Wyngarden as inventor.

This application relates to co-pending U.S. patent application Ser. No. 09/158,564, filed on Sep. 22, 1998, entitled Method and Apparatus For Providing Customer Configured Machines at an Internet Site, naming Ken Henson as inventor.

This application relates to co-pending U.S. patent application Ser. No. 09/244,473, filed on Feb. 4, 1999, entitled System and Method For Identification and Streamlined Access to Online Services, naming David S. Springer as inventor.

This application relates to co-pending U.S. patent application Ser. No. 09/290,027, filed on Apr. 9, 1999, entitled Interactive Upsell Advisor Method and Apparatus For Internet Applications, naming John W. Notz and Andrew Hefele as inventors.

These co-pending applications are incorporated herein by reference in their entirety, and are assigned to the assignee of this invention.

Currently, when a potential customer contacts a vendor via telephone to order a build-to-order PC, he or she spends a substantial amount of time on the telephone with a sales representative of the vendor discussing the various possible configurations of the PC, as well as the costs associated with each of those configurations. Often, the customer will not order a PC during that initial conversation, but will want to take some time to consider the decision further and actually place the order at a later time.

The problem with the foregoing scenario is that if the customer chooses to call the sales representative back to order the selected configuration, he or she runs the risk that the sales representative will not be available at the time the call is placed, forcing the customer to leave a message and rely on the sales representative to subsequently contact him or her. Alternatively, if the customer chooses to go on-line to order the selected configuration via the vendor's web site, he or she will essentially have to “rebuild” the PC that he or she previously spent a substantial amount of time building on the telephone with the sales representative. Clearly, either of these results in a substantial waste of time for the customer ordering the PC.

Therefore, what is needed is a system for enabling a customer quickly and easily to order a selected configuration of a PC via telephone or the vendor's web site without having to essentially “rebuild” the selected configuration.

### SUMMARY

One embodiment, accordingly, provides a method and apparatus for providing a customer with a quote number identifying a selected PC configuration, which quote number can be later provided by the customer either via telephone or the vendor's web site to facilitate the process of ordering the PC. To this end, a computer server is operated to provide configuration and quotation information to a user. A quotation number previously provided to the user by a sales representative is received by the computer server. The user configuration and quote information corresponding to the quotation number is also provided to the user.

A principal advantage of this embodiment is that a substantial amount of the customer's time is saved by not requiring him or her either to reach the sales representative with whom he or she initially spoke or reconstruct the selected configuration on-line to order a PC. In addition, the service is available 24 hours a day, seven days a week, 365 days a year.

### BRIEF DESCRIPTION OF THE DRAWING FIGURES

FIG. 1 is a diagrammatic view of a network for hosting and accessing a web site of an embodiment.

FIG. 2 illustrates a Quote to Order page of the web site of FIG. 1.

FIG. 3 illustrates a Vendor Quotation page of the web site of FIG. 1.

FIG. 4 illustrates a Member Services Registration page of the web site of FIG. 1.

### DETAILED DESCRIPTION

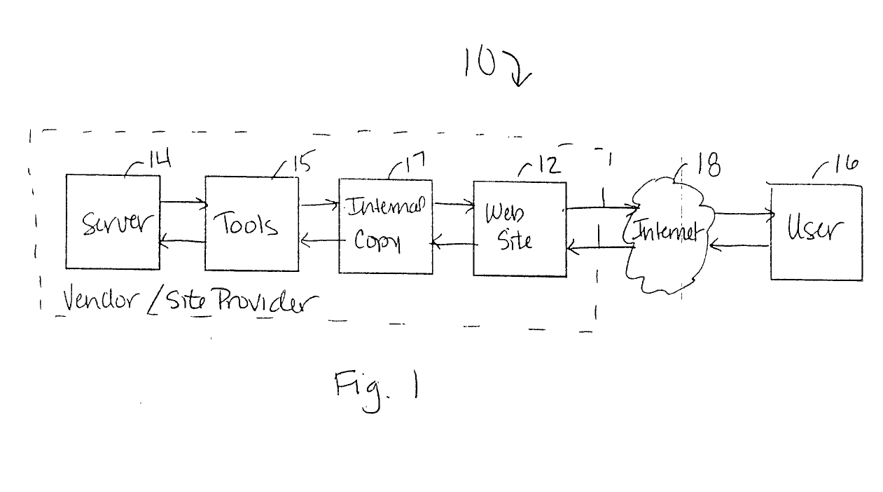

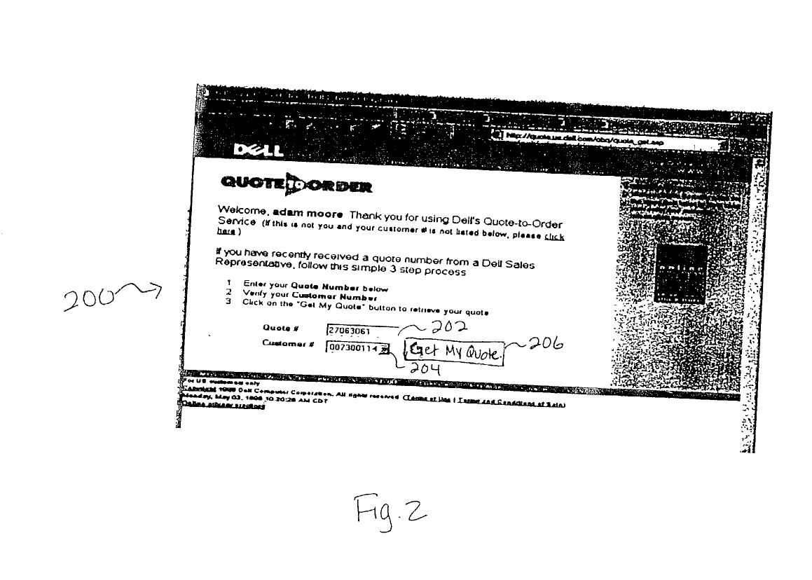

Referring to FIG. 1, a network 10 includes a web site 12 including several web pages (FIGS. 2-4) coupled to a first user point, or server, 14 and a second user point 16. The server 14 as used in this context is any terminal on a private network used by a vendor/site provider to input managed information to the web site 12. The second user point 16 as used in this context is any terminal used by a site user via the Internet to access all or part of the managed information at the web site 12.

The site provider at server 14 writes to a series of Internet tools 15 and publishes to an internal copy 17 of the web site 12 for pre-production purposes. Ultimately, the site provider publishes to the web site 12. The site user at second user point 16 has access to web site 12 via an Internet connection 18 and can also communicate directly via a link 19 with the site provider at server 14 via, for example, e-mail for the purpose of submitting orders for goods offered for sale at the web site 12. Additionally, the site provider directly accesses the web site 12 for maintenance purposes, e.g., to access the web site 12 to monitor traffic to the site and the quality of the site.

As will be described in greater detail with reference to FIGS. 2-4, the web site 12 includes a number of web pages that include customized information to provide users at second user point 16 with an easier way of doing business with a site provider at server 14. As will be recognized by those skilled in the art, the web pages reside on the web site 12 behind a universal resource locator (“URL”).

In a preferred embodiment, a customer contacts a sales representative of a vendor via telephone for assistance in ordering a build-to-order PC. Typically, the customer will spend a substantial amount of time on the telephone with a sales representative discussing the various possible configurations of the PC, as well as the costs associated with each of those configurations. Often, the customer will not order a PC during that initial conversation, but will want to take some time to consider the decision further and actually place the order at a later time. If that is the case, once the customer has decided on a configuration, the sales representative will provide the customer with a unique quote number identifying the selected configuration, information about the customer, and any other information the possession of which is necessary or useful in subsequently ordering the selected configuration. Later, as described in detail below with reference to FIGS. 2-4, when the customer has decided to order the PC, he or she simply accesses the web site of the vendor, enters the quote number in the appropriate field, and clicks on a “place order” button or menu selection, thereby ordering the PC on-line.

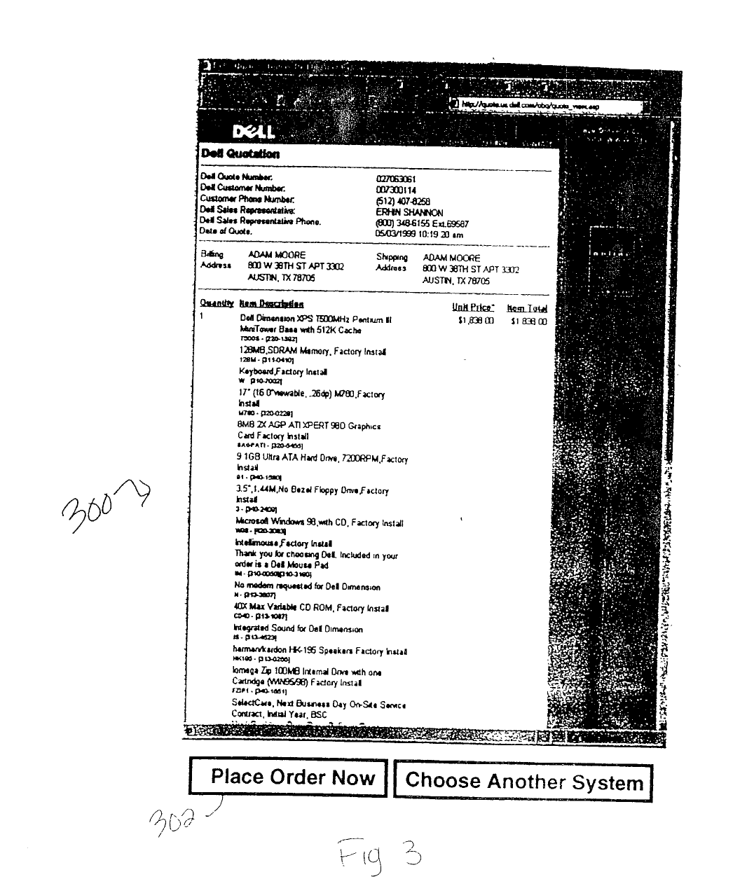

In particular, as indicated above, once a customer who has been given a quote number decides to order a PC on-line, the customer accesses the web site 12 of the vendor and goes to a “Quote to Order” page 200, as illustrated in FIG. 2. Using the Quote to Order page 200, the customer enters his or her quote number in a field 202, verifies a previously assigned customer number pre-entered in a field 204, and clicks on or otherwise selects a button 206 designated “Get My Quote”, responsive to which a “Vendor Quotation” page 300, as illustrated in FIG. 3, is displayed. It will be recognized that the customer number is a number assigned to the individual or corporate customer and will have been previously conveyed to the customer in one of a number of known manners.

The Vendor Quotation page 300 contains all of the relevant quotation presumably discussed by the customer and sales representative during their previous telephone conversation and necessary to enable the customer to make a purchase decision. In particular, the quote information includes a description of the PC and the total price. If the customer is satisfied with the quotation and desires to order the PC, he or she clicks on or otherwise selects a button 302 designate “Place Order Now” to finalize the purchase on-line in a conventional fashion.

In a preferred embodiment, the name and address of the customer are also prepopulated on the order form through use of the quote number, saving the customer additional time.

If the customer decides not to order the PC, he or she clicks on or otherwise selects a button 304 designated “Choose Another System” to select another system to order.

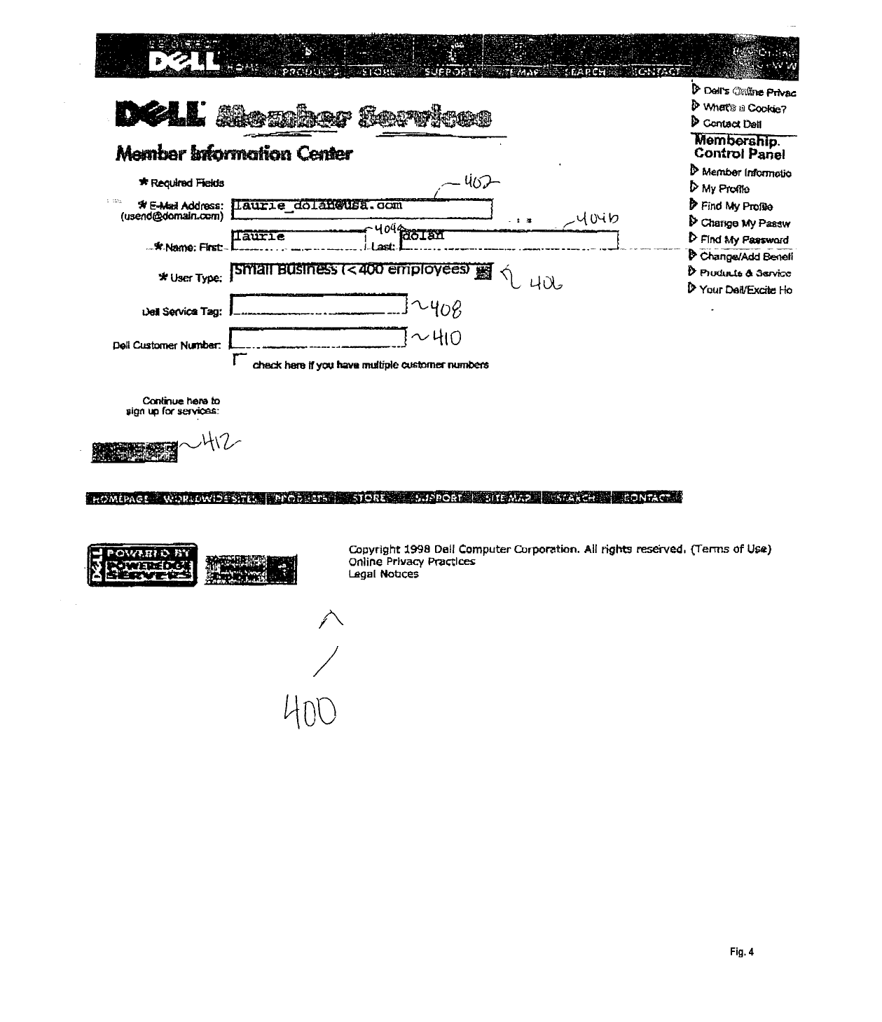

In one aspect, prior to the first time a customer makes use of the previously described service, he or she must register with “Member Services” as a means of providing a level of data protection. In this regard, FIG. 4 illustrates a “Member Services Registration” page 400. As shown in FIG. 4, using the Member Services Registration page 400, the customer is prompted to enter his or her E-mail address in a field 402 and first and last names in fields 404a, 404b, respectively. In addition, the customer must select a “User Type” (e.g., “Small Business (>400 employees)”) from a drop-down menu 406. The foregoing information is required; the customer may also enter a Service Tag in a field 408 and a Customer Number 410 in a field 410. Once the required information and any additional information has been entered, the customer clicks on a button 412 to submit the information and sign up for member services, including the “quote-to-order” service described herein.

Alternatively, the customer may contact the vendor via telephone and provide the quote number to any available sales representative, whether or not that sales representative is the one who originally assisted the customer in configuring the PC, to enable that sales representative to place the order for the customer.

Although an illustrative embodiment has been shown and described, other modifications, changes, and substitutions are intended in the foregoing disclosure. Accordingly, it is appropriate that the appended claims be construed broadly and in a manner consistent with the scope of the disclosure.

What is claimed is:

1. A method of operating a computer server to provide configuration and quotation information to a user, the method comprising the steps of:
receiving by the computer server a quotation number previously provided to the user by a sales representative; and
providing to the user configuration and quote information corresponding to the quotation number.

2. The method of claim 1 wherein the quotation number is received from a user at a user terminal.

3. The method of claim 1 wherein the receiving and providing is accomplished via an Internet connection between the server and the user.

4. The method of claim 3 wherein the quotation number is entered by the user in a designated field of an Internet web site.

5. The method of claim 1 wherein the server is maintained by a vendor.

6. The method of claim 5 wherein the quotation number is provided to the user during a telephone conversation with a sales representative of the vendor.

7. Apparatus for operating a computer server to provide configuration and quotation information to a user comprising:
means for receiving by the computer server a quotation number previously provided to the user by a sales representative; and
means for providing to the user configuration and quote information corresponding to the quotation number.

8. The apparatus of claim 7 wherein the quotation number is received from a user at a user terminal.

9. The apparatus of claim 7 wherein the receiving and providing is accomplished via an Internet connection between the server and the user.

10. The apparatus of claim 9 wherein the quotation number is entered by the user in a designated field of an Internet web site.

11. The apparatus of claim 7 wherein the server is maintained by a vendor.

12. The apparatus of claim 11 wherein the quotation number is provided to the user during a telephone conversation with a sales representative of the vendor.

13. A system for providing quotation and configuration information to a user comprising:
a server for receiving a quotation number and for providing quotation and configuration information corresponding to the quotation number; and
a user terminal connected to the server for receiving the quotation and configuration information from the server.

14. The system of claim 13 wherein the quotation number is received by the server from the user terminal.

15. The system of claim 13 wherein the server and user terminal are connected via an Internet connection.

16. The system of claim 15 wherein the quotation number is entered by the user in a designated field of an Internet web site.

17. The system of claim 15 wherein the server is maintained by a vendor.

18. The system of claim 17 wherein the quotation number is provided to the user during a telephone conversation with a sales representative of the vendor.
